(19) United States
(12) Patent Application Publication
(10) Pub. No.: US 2006/0272678 A1
(43) Pub. Date: Dec. 7, 2006

(54) METHOD AND APPARATUS FOR A TAPE-REWINDING SUBSTRATE CLEANER

(76) Inventors: Frank C. Corrado, Rochester, NY (US); Gary R. Larsen, Webster, NY (US); Ronald W. Sweet, Conesus, NY (US); James W. Fischer, Rochester, NY (US)

Correspondence Address: JAECKLE FLEISCHMANN & MUGEL, LLP, 190 Linden Oaks, ROCHESTER, NY, 14625-2812, US

(21) Appl. No.: 11/422,236

(22) Filed: Jun. 5, 2006

Related U.S. Application Data
(60) Provisional application No. 60/687,575, filed on Jun. 6, 2005.

(51) Int. Cl. B08B 1/00

(52) U.S. Cl. 134/6; 15/256.51

(57) ABSTRACT

A cleaner assembly for cleaning a roller comprising a tape unwinder and winder for holding and dispensing adhesive tape which may be a continuous strip or may comprises discrete sheets of adhesive tape wound on top of each other. The winder and unwinder are connected to a drive by a timing belt. Thus a length of tape may be wound back and forth on a roller surface by alternating the rotation of the drive. The tape is passed around a backing roller to press the tape against a roller to be cleaned. In a second embodiment, the tape roll comprises a plurality of sheets of tape wound on top of each other. To remove a spent outer sheet, the outer sheet carrying the transferred particles is transferred to a continuous tape roll, exposing a fresh sheet on the sheeted tape roll which is then ready for renewed cleaning service.

The present application draws priority from a pending U.S. Provisional Patent Application, Ser. No. 60/687,675, filed Jun. 6, 2005.

### TECHNICAL FIELD

The present invention relates to method and apparatus for cleaning particles from a substrate; more particularly, to method and apparatus for cleaning particles from the surface of a process roller; and most particularly, to method and apparatus for cleaning particles from a roller surface by contact with an adhesive-covered tape which may be rewound for repeated use.

### BACKGROUND OF THE INVENTION

Methods and apparatus for cleaning particles from sheets and rollers by impingement of an adhesive-covered tape are well known. See, for example, U.S. Pat. Nos. 4,009,047 and 6,196,128.

Adhesive-covered tape (referred to herein for simplicity as “adhesive tape) as used in the prior art can be an expensive medium for removing particles from a substrate, as the adhesive capabilities of the tape typically are far from exhausted in prior art applications. In addition, cleaning of relatively wide rollers by tape requires either an equivalently wide adhesive tape, which is very costly, or the progression of a narrower tape element along the surface to be cleaned.

Further, the operation of prior art systems for using and renewing adhesive tape cleaners is highly labor-intensive, requiring that an operator be present to remove the length of spent tape and establish a fresh tape adhesive surface on the surface to be cleaned. See, for example, U.S. Pat. No. 6,196,128 B1.

What is needed in the art is a method and apparatus for increasing the utility of adhesive tape for cleaning by reusing a tape element in a controlled, predictable, and automated way.

What is further needed is an automated system for removing from a work zone a length of spent tape and establishing a fresh length of tape in the work zone.

It is a principal object of the present invention to improve the use of adhesive tape as a substrate cleaning medium.

### SUMMARY OF THE INVENTION

Briefly described, a cleaner assembly for cleaning a roller comprises a tape unwinder for holding and dispensing adhesive tape. The adhesive tape may be a continuous strip or may comprises discrete sheets of adhesive tape wound on top of each other. In a first embodiment of a cleaner assembly in accordance with the invention, the tape roll is held in place by a spring-loaded gudgeon and by a drive having a one-way clutch that free-wheels in the tape forward direction but engages in the reverse direction. A tape winder is similarly equipped except that it winds in the forward direction and free-wheels in the reverse direction. The two drives are connected by a timing belt that also includes a motorized drive pulley. Thus a length of tape may be wound back and forth between the unwinder and the winder by alternating the rotation of the drive. Preferably, the tape is wound with its adhesive side out and may be passed around a backing roller (although not necessarily) for pressing the tape against a substrate to be cleaned. Pressure of the backing roller may be varied. A tach sensor at the backing roller tracks the length of tape passed in either direction. The cleaning head may be mounted on a rail for axial movement such that a substrate, such as a roller longer than the width of the tape, may be cleaned by moving the head in discrete stages along the roller.

In a second embodiment, the tape roll comprises a plurality of discrete lengths of tape, herein referred to as “sheets”, wound on top of each other. Such a tape roll is referred to herein as a “sheeted tape roll”. The outer sheet has an end exposed, and the tape roll is rotated against the substrate to be cleaned in a direction such that the exposed end is trailing. To remove the outer sheet after it is spent, the tape roll is impinged against a continuous tape roll such that the outer sheet adhering the transferred particulates is transferred to the continuous tape roll, exposing a fresh sheet on the sheeted tape roll which is then ready for renewed cleaning service.

### BRIEF DESCRIPTION OF THE DRAWINGS

The present invention will now be described, by way of example, with reference to the accompanying drawings, in which:

FIG. 1 is a schematic elevational view of a prior art system for using adhesive tape to clean a contact cleaning roller, as disclosed in U.S. Pat. No. 6,196,128 B1;

FIG. 2 is a schematic cross-sectional view of a prior art sheeted tape roll as disclosed in U.S. Patent Application Publication No. US 2006/0057322 A1;

FIG. 3 is a schematic cross-sectional view of a prior art system for employing the sheeted tape roll shown in FIG. 2 for cleaning a contact cleaning roller as disclosed in U.S. Patent Application Publication No. US 2006/0057322 A1;

FIG. 4 is an elevational end view of a first embodiment of a tape cleaning system in accordance with the invention;

FIG. 4a is a detailed end view of the first embodiment shown in FIG. 4, showing typical operation of the system in accordance with the invention;

FIG. 5 is an elevational side view of the tape cleaning system shown in FIG. 4;

FIG. 6 is an elevational end view showing an alternative backing roller for a tape cleaning system in accordance with the invention;

FIG. 7 is an elevational side view of a second embodiment of a tape cleaning system in accordance with the invention;

FIG. 8 is an end view of a third embodiment of a substrate cleaning system in accordance with the invention, showing the system in a first operating position;

FIG. 9 is a view of the third embodiment shown in FIG. 8, showing the system in a second operating position;

FIG. 10 is a schematic drawing of a control and alarm module for the system shown in FIG. 4;

FIG. 11 is an elevational end view of a fourth embodiment of a substrate cleaning system in accordance with the invention;

FIG. 12 is an elevational end view of a fifth embodiment of a substrate cleaning system in accordance with the invention; and

FIGS. 13 through 15 show three stages in renewal of a sheeted tape roll in accordance with the invention.

### DESCRIPTION OF THE PREFERRED EMBODIMENTS

In broadest terms, the present invention is directed to apparatus and methods for bringing an adhesive tape surface into contact a plurality of times with a substrate to be cleaned. The prior art, as exemplified in U.S. Pat. Nos. 4,009,047 and 6,196,128, and U.S. Patent Application Publication No. U.S. 2006/0057322 A1, does not suggest or disclose to use an adhesive tape surface for more than one pass in contact with a substrate to be cleaned, such as a process roller or CCR. Such repeated usage in accordance with the present invention can greatly reduce the cost of operating roller cleaning systems wherein a CCR is cleaned by being brought into contact repeatedly with a length or circumference of adhesive tape.

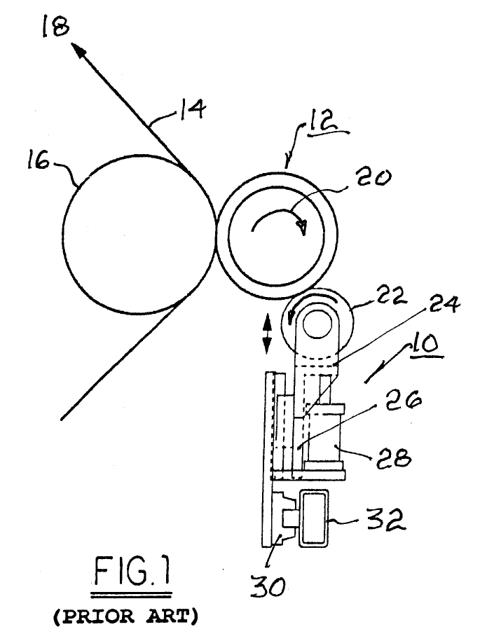

Referring to FIG. 1, a prior art system 10 is shown for cleaning the surface of a process roller 12, such as a contact cleaning roller (CCR). System 10 is substantially as disclosed in U.S. Pat. No. 6,196,128 B1, the relevant disclosure of which is incorporated herein by reference. CCR 12 is in nipped contact with a web substrate 14 wrapped around a backing roller 16 and moving in a direction 18 such that CCR 12 rotates clockwise 20 as shown. By engaging in rolling contact with web substrate 14, CCR 12 removes particulate contamination from the surface of web substrate 14 and transfers such contamination onto the surface of CCR 12 in known fashion. CCR 12 is also known in the art as a “particle transfer” roller, the surface of which typically is formed of a triboelectric material such as polyurethane or silicone rubber which attracts particles with a greater force than the surface of web substrate 14.

CCR 12, or any other type of process roller, must be cleaned of accumulated particulate debris from time to time, to maintain a healthy process. In the case of a CCR, the particle removing effectiveness of the roller tends to diminish as the roller surface accumulates particles. Prior art system 10 renews the surface of CCR 12 by removing accumulated particles therefrom.

System 12 comprises a secondary CCR 22 may be similar to the surface of primary CCR 12, in that it may be formed of a resilient polymer having a high surface energy such as polyurethane, silicone rubber, butyl rubber, neoprene, or the like, or it may be formed of a tacky polymer such as a tape adhesive; for example, CCR 22 may comprise a multiple-convolution roll of adhesive tape wound on a core with the adhesive side facing outwards. A suitable tape, for example, is “Scotch Brand Tape No. 850” available from 3M Corporation, St. Paul, Minn., or its equivalent. Whatever material is selected for the surface of secondary CCR 22, it is important that the surface tack be substantially greater than the surface tack of primary CCR 12 to assure transfer of particles to CCR 22. Prior art system 10 further comprises mounting means 24 for supporting CCR 22. Mounting means 24 is slidably disposed on a vertical guide 26 for variable vertical actuation thereof by a controllable linear solenoid actuator 28. System 10 is mounted via a bearing element 30 on a track 32 for traversing secondary CCR 22 across the surface of primary CCR 12 in an axial direction thereof, either continuously or intermittently at a sequence of axial positions. Secondary CCR 22 is not powered for rotation but rather is rotated along the surface of primary CCR 12 by frictional contact therewith.

As noted above, an operational disadvantage of prior art system 10 is that operator involvement is frequent, either to wash secondary CCR 22 as it gets dirty, when the surface is a triboelectric polymer; or to remove an outer convolution of adhesive tape, when CCR is an roll of adhesive tape, when the adhesive surface becomes loaded with particles removed from primary CCR 12.

The remainder of this discussion, and the present invention, are directed to roller cleaning systems wherein the primary CCR is cleaned by being brought into contact repeatedly with a length or circumference of adhesive tape.

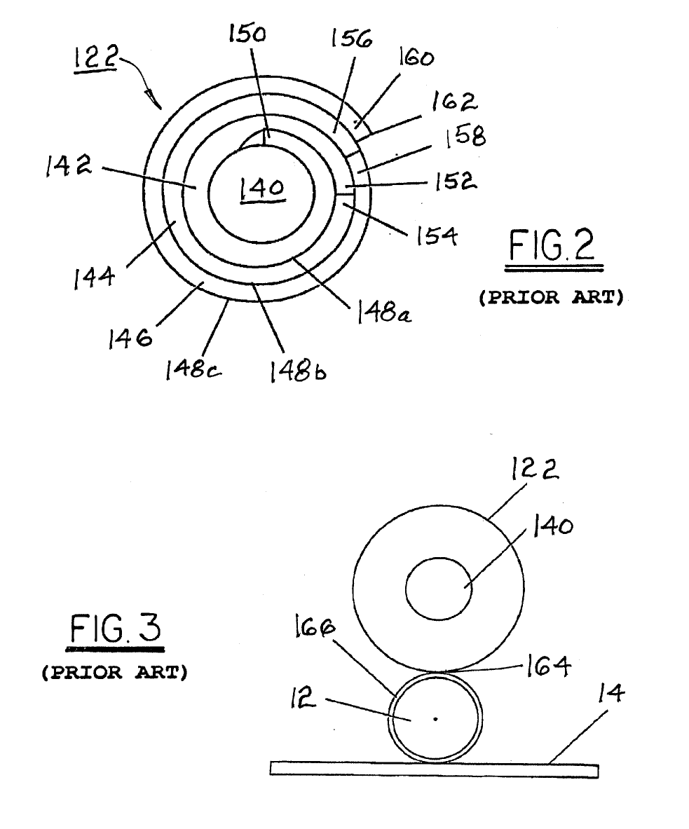

Referring now to FIGS. 2 and 3, a prior art sheeted roll of adhesive tape 122 is substantially as disclosed in U.S. Patent Application Publication No. US 2006/0057322 A1. Sheeted tape roll 122 comprises a conventional roll core 140 with individual adhesive sheets 142, 144, 146 removably attachable around the circumference of the roll core 140 superimposed onto one another. The roll core 140 has an attachment means which may be an adhesive coating to allow the first individual adhesive sheet 142 to be removably attachable around the circumference of the roll core 110. The individual adhesive sheets 142, 144, 146 have an adhesive surface 148a-c facing outwardly, and have a non-adhesive surface facing inwardly. Alternatively the individual sheets can be rolled such that the adhesive surfaces are facing inwardly and the non-adhesive surfaces are facing outwardly.

The sheeted roll 122 is formed by attaching a first end 150 of the first sheet 142 onto the roll core 140 and wrapping the first sheet 142 around the circumference of the roll core 140. The other end 152 of the first sheet 142 will overrun first end 150 by virtue of first sheet 142 being greater in length than the circumference of the roll core 140. The end 152 is removably attached onto end 150 by the adhesive surface 148a of the first sheet 142.

A second sheet 144 is then wrapped around the outer circumference of the first sheet 142 with end 154 of the second sheet 144 being abutted to end 152 of the first sheet 142. The term abutted is to be understood to include being adjacent to, as there may be a gap between successive sheets. The adhesive surface 148a of the first sheet 142 will securely hold in place the second sheet 144.

A third sheet 146 is then wrapped around the outer circumference of the second sheet 144 with end 158 of the third sheet 116 being abutted to end 156 of the second sheet 114. The adhesive surface 148b of the second sheet 144 will securely hold in place the third sheet 146. Similarly, further individual adhesive sheets (not shown) are abutted to end 160 of the third sheet 146 and so on until the roll core 140 is “full”.

It will be realized that because the sheets 142, 144, 146 are all of the same length, the overrun or circumferential offset of the respective ends 152, 156, 160, and so on, will decrease as the roll core 140 becomes “full”. The length of each sheet can however be adjusted as desired or required. The offset of the abutment of the ends of the sheets disperses the load on the roll core 140 making the roll core 140 more stable when rotating.

Referring to FIG. 3, in use, the roll core 140 is positioned such that the outermost sheet of sheeted roll 122 is positioned in contact at a point 164 with the cleaning surface 166 of CCR 12. As both the roll core 140 and the cleaning roll 12 rotate, impurities located on the cleaning surface 166 will be transferred to the adhesive surface of the outer sheet of sheeted tape roll 122. When the adhesive surface of the outer sheet becomes contaminated, replacement is achieved simply by peeling the contaminated sheet away by virtue of lip 162, thus leaving behind a clean sheet to be applied to the cleaning surface 166 of the cleaning roll 12, until that sheet too needs replacement, and so on.

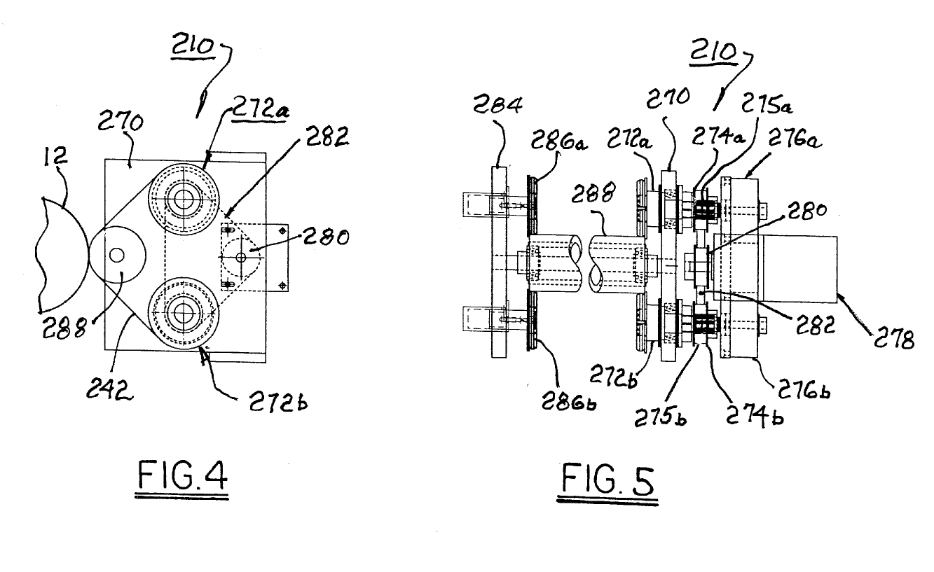

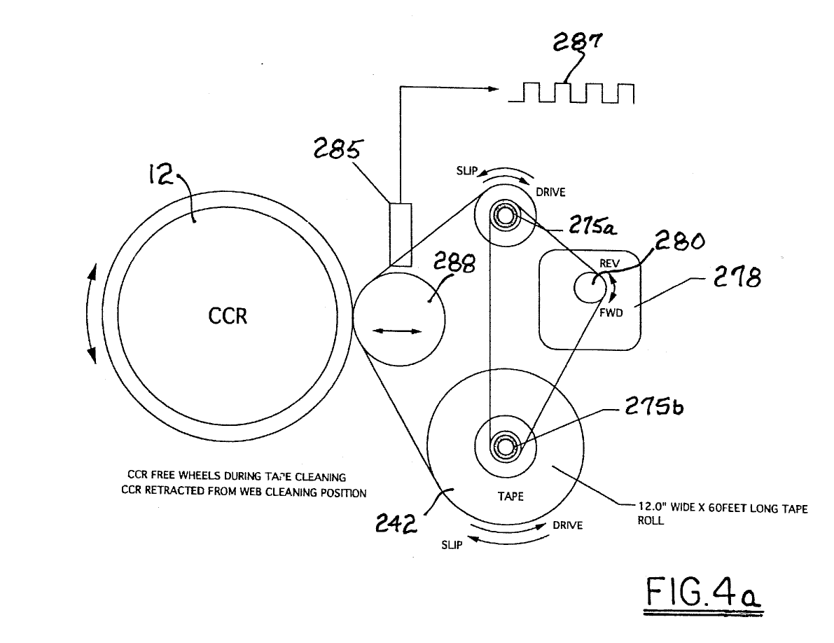

Referring now to FIGS. 4, 4a, and 5, a first embodiment 210 of a substrate cleaner in accordance with the invention comprises a turret 270 including first and second winding spindles 272a,272b having first and second timing pulleys 274a,274b and first and second one-way clutches 275a,275b and first and second magnetic particle clutch brakes 276a,276b, respectively, for tension control between the spindles. A reversible tape wind drive motor 278 is provided with an output pulley 280. A timing belt 282 connects output pulley 280 and timing pulleys 274a,274b. A tailstock stand 284 includes first and second spring-loaded spindle gudgeons 286a,286b for removably mounting two tape-supporting cores (not shown) to first and second winding spindles 272a,272b, respectively. A backing roller 288 is disposed for idle rotation between turret 270 and stand 284. A continuous adhesive tape web 242 wound onto one of the cores, preferably at spindle 272a, is led (adhesive side facing outwards) around backing roller 288 and attached to an empty core mounted at the other spindle. Tape web 242 may be advanced from spindle 272a, around backing roller 288, and onto spindle 272b by energizing motor 278 in a first direction. Because motor 278 is reversible, the tape web may also be driven in the reverse direction from spindle 272b onto spindle 272a, in accordance with the present invention.

A currently-preferred method for cleaning a roller such as a CCR 12 comprises the minimum steps of:

a) engaging the tape web with the CCR surface by advancing the backing roller (CCR is in idler mode);

b) passing a predetermined first length (preferably 48 inches, as measured by tach sensor 285 and length counter 287) of tape over the CCR surface between the unwinder spindle and the winder spindle to clean the CCR surface a first time; and

c) rewinding the length of tape onto the unwinder spindle to clean the CCR surface a second time.

Thus the first length of tape is used twice as a roller cleaner. The spent first length of tape may then be advanced permanently onto the winder spindle and stored for later discard, exposing a new, second length of fresh tape, or the first length may be used yet again if its adhesive properties are not significantly diminished. The tape length may be further re-used until it fails to adequately remove particles from the surface to be cleaned.

In cleaning a CCR having an axial length longer than the width of the tape to be employed, the roller may be cleaned in successive stages by moving the tape to successive cleaning positions along the roller, in accordance with the following process steps:

a) retracting the CCR from a substrate it has been cleaning (CCR is in idler mode);

b) advancing the cleaning system to a first cleaning zone on the CCR;

c) engaging the tape with the CCR surface by advancing the backing roller;

d) passing a predetermined first length (preferably 48 inches) of tape over the CCR between the unwinder spindle and winder spindle to clean the first cleaning zone a first time;

e) rewinding the first length of tape onto the unwinder spindle to clean the first zone a second time;

f) retracting the backing roller and tape from the CCR surface;

g) re-advancing the tape to place the first predetermined length of tape permanently on the winder spindle;

h) moving the cleaning system to the next cleaning zone on the CCR (which preferably overlaps slightly the first cleaning zone);

and i) repeating steps c) through h) until the entire CCR has been cleaned.

Referring to FIG. 6, backing roller 288 may be provided with a relatively compliant (soft) surface layer 288a, which can be a benefit in assisting system 210a in cleaning rollers (typically not CCRs) having surfaces of varying depth or diameter wherein the adhesive tape may be conformably adapted to the roller surface.

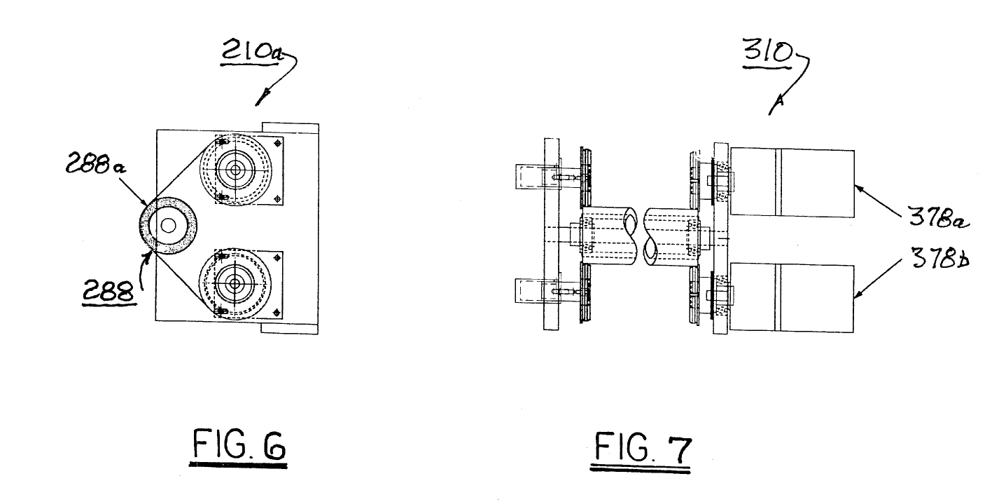

Referring to FIG. 7, in a second embodiment 310 of a substrate cleaner in accordance with the invention, the particle brakes, timing pulleys, timing belt, and one-way clutches shown for first embodiment 210 are replaced by first and second torque motors 378a,378b for driving spindles 372a,372b, respectively. Tension regulation of the tape is readily accomplished by coordination of the two torque motors.

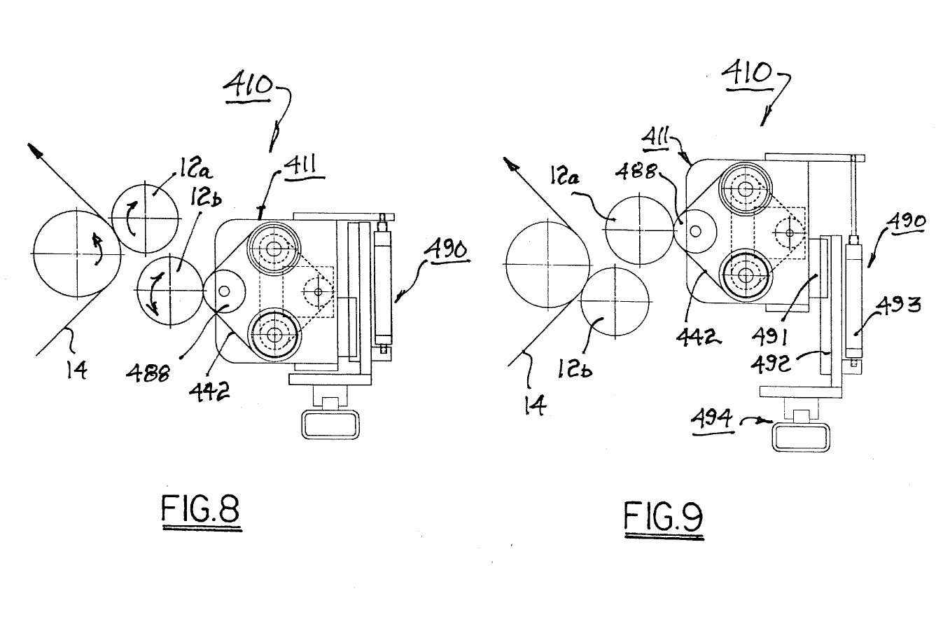

Referring to FIGS. 8 and 9, in a third embodiment 410 of a substrate cleaner in accordance with the invention, the cleaner assembly 411 includes a lift mechanism 490 for adjusting the vertical position of the assembly so that tape 442 passing around backing roller 488 may engage either of two primary CCRs 12a,12b being used alternately for continuous cleaning of a moving substrate web 14. The out-of-service CCR is cleaned while the other CCR is in service, allowing for continuous substrate cleaning without the need to stop the substrate to rejuvenate a single CCR. Lift mechanism 490 includes a car 491 that rides on a vertical rail 492, and a hydraulic piston 493 attached to mechanism 411, which entire assembly may be translated axially of the CCRs on a horizontal rail 494.

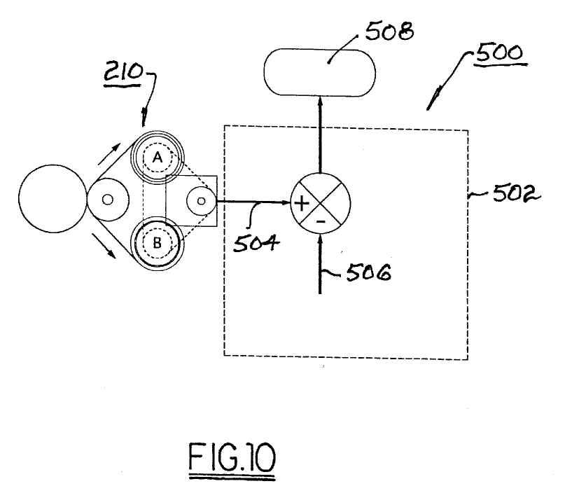

Referring to FIG. 10, a control and alarm module 500 for the system 210 shown in FIG. 4 comprises a signal processor 502 for comparing a motor amp signal 504 to a predetermined set point signal 506 and energizing an alarm 508 when the motor amp signal equals the set point signal. In operation, a roll of adhesive tape may be wound from the A spindle to the B spindle and then reversed, B to A, until the entire roll of adhesive tape is spent, in accordance with the previously described steps. Monitoring the motor current during the winding process provides feedback as to the cleanliness of the adhesive tape in contact with the CCR. As the tape progressively accumulates particles, the tack of the tape decreases, leading to a progressive reduction in motor amps necessary to unwind the tape and drive the tape over the surface of the CCR. A motor amp signal indicative of a spent roll of tape is predetermined and is programmed into the processor as the set point. The tape may then be advanced to store the spent portion permanently on the winder and to present a fresh length of tape for repeated rewinding use. Thus, system 210 when coupled to control and alarm module 500 can run without operator supervision or intervention for the full length of a roll of adhesive tape.

Referring to FIG. 11, in a fourth embodiment 610 of a substrate cleaner in accordance with the invention, a tape backing roller such as roller 288 in first embodiment 210 is omitted from the cleaner assembly 611, creating a free span 607 of tape 242 between first and second spindles 672a,672b. Free span 607 provides conformance with the surface to be cleaned of roller 612 and thereby allows cleaning of irregularly shaped or contoured rollers, such as convex, concave, or bowed rollers.

Free span 607 also allows for cleaning of very low durometer rollers, and even foam rubber rollers, that might be damaged by line pressure from a hard backing roller such as roller 288.

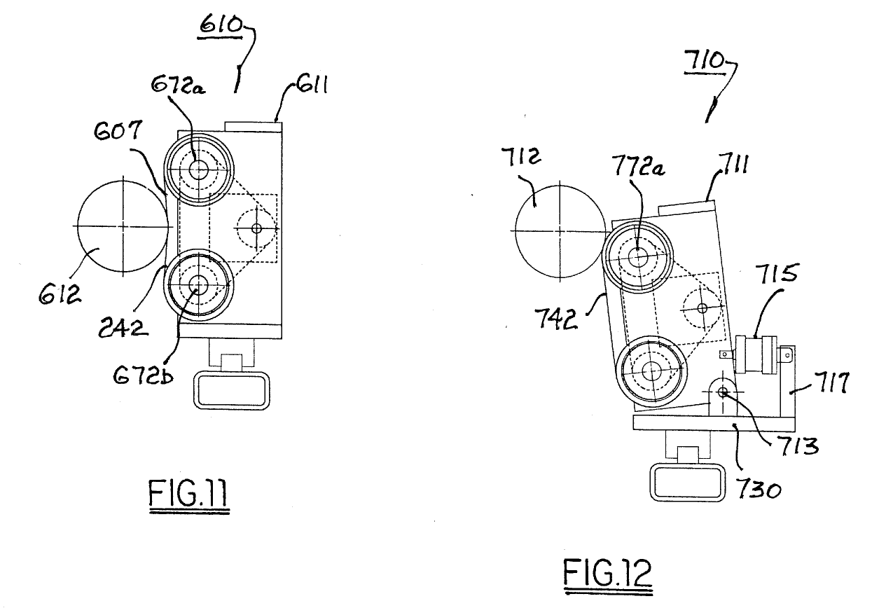

Referring to FIG. 12, in a fifth embodiment 710 of a substrate cleaner in accordance with the invention, a cleaner assembly 711 similar to assembly 611 is mounted on a rail car 730 for pivoting about a horizontal axis 713. Assembly 611 is positioned vertically such that the tape roll associated with first spindle 772a functions like a backing roller for tape 742 being pressed against a roller 712 to be cleaned. The pressure exerted by the tape against the roller may be controlled via a controllable actuator 715, preferably pneumatic, disposed between the assembly 711 and a flange 717 on rail car 730. In this configuration, the particle clutch brakes 275a,275b required in embodiment 210 may be eliminated.

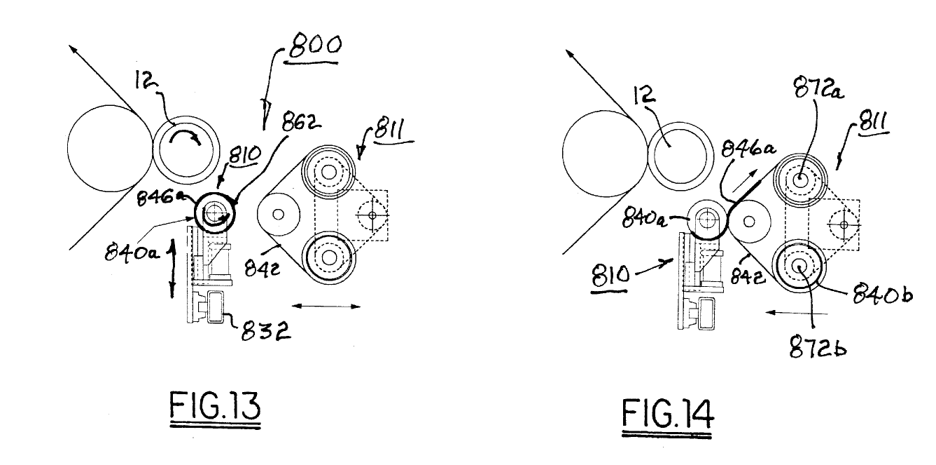

Referring now to FIG. 13, in a sixth embodiment 800 of a substrate cleaner in accordance with the invention, a first cleaner assembly 810, similar to assembly prior art assembly 10 (FIG. 1), is provided with a first sheeted tape roll 840a, similar to prior art sheeted tape roll 140 (FIG. 2) in replacement of secondary CCR 22 for cleaning primary CCR 12. Like secondary CCR 22, sheeted tape roll 840 defining a secondary CCR may be raised into contact with primary CCR 12 and allowed to be driven by such contact through multiple revolutions of roll 840a, and multiple contacts of outer tape sheet 846a with CCR 12, as may be desired, thus fully utilizing the adhesive capability of outer sheet 846a. Further, secondary CCR 840a may be retracted, moved along rail 832 to a new axial position adjacent primary CCR 12, and re-engaged therewith for additional revolutions of roll 840a.

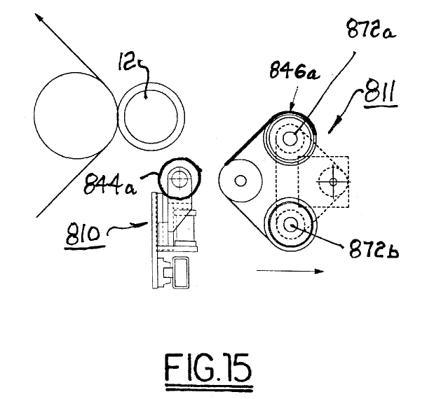

Referring now to FIGS. 14 and 15, renewal of sheeted tape roll 840a is carried out in a fashion similar to the renewal of a secondary CCR as shown variously in embodiments 210 (FIGS. 4 and 10) and 410 (FIGS. 8 and 9). Accumulated particles on sheeted tape roll 840a are transferred to a continuous adhesive tape roll 840b mounted on a cleaner assembly 811 in similar fashion to those previously discussed in accordance with the invention, except that the entire spent tape sheet carrying the particles is also transferred.

Note that roll 846a is mounted for rotation in cleaning use in a counterclockwise direction, as shown in FIG. 13, such that winding lip 862 (analogous to prior art lip 162 in FIG. 2) is trailing. Cleaner assembly 811 is advanced to bring tape surface 842 into contact with lip 862. The lip is engaged therewith, and rotation of spindles 872a,872b causes the spent outer tape sheet 846a to be unwound from sheeted tape roll 840a and wound onto adhesive tape surface 842 whereon it is stored on spindle 872a for eventual discard when all of roll 840b is consumed. Cleaner assembly 811 is retracted, and the next fresh sheet 844a on cleaner assembly 810 is now fully exposed and ready for use in further cleaning of CCR 12. Sheet 844a and all additional sheets on sheeted tape roll 840a may be similarly stripped and stored on continuous tape roll 840b as needed.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A system for cleaning particles from the surface of a roller, comprising:
a) means for conveying a length of adhesive tape in rolling contact with said roller surface in a first rolling direction;
b) means for conveying said length of adhesive tape in rolling contact with said roller surface in a second rolling direction opposite said first rolling direction; and
c) means for switching said rolling contact between said first rolling direction and said second rolling direction.

2. A system in accordance with claim 1 wherein said length of tape is a portion of a roll of continuous tape having a first core, and wherein said means for conveying in said first rolling direction comprises:
a) first and second spaced apart spindles for unwinding and winding said continuous tape between said first core on one of said spindles and a second core disposed on the other of said spindles;
b) drive means for driving said first and second spindles;
c) clutch means engageable on said first spindle; and
d) clutch means slipable on said second spindle.

3. A system in accordance with claim 2 wherein said means for conveying in said second rolling direction comprises:
a) clutch means slipable on said first spindle; and
b) clutch means engageable on said second spindle.

4. A system in accordance with claim 3 wherein each of said first and second spindles is provided with particle brake means.

5. A system in accordance with claim 2 wherein said drive means includes a reversible electric motor operatively connected to said first and second spindles.

6. A system in accordance with claim 2 wherein said drive means includes first and second reversible torque motors operatively connected to said first and second spindles, respectively.

7. A system in accordance with claim 2 wherein said roller to be cleaned by said system is a contact cleaning roller.

8. A system in accordance with claim 7 wherein said contact cleaning roller is a sheeted tape roller having a plurality of adhesive sheets wrapped upon a core, and wherein said system includes means for transferring the outermost of said adhesive sheets from said sheeted tape roller to said length of adhesive tape.

9. A method for cleaning particles from the surface of a roller, comprising the steps of:
a) conveying a length of adhesive tape in rolling contact with said roller surface in a first rolling direction; and
b) conveying said length of adhesive tape in rolling contact with said roller surface in a second rolling direction opposite to said first rolling direction.

10. A method in accordance with claim 9 wherein said steps a) and b) are repeated a plurality of times.

11. A method in accordance with claim 9 wherein said length of adhesive tape is a first length which is a portion of a roll of continuous tape, the method further comprising the steps of:
a) winding said first length of adhesive tape into a storage location for discard;
b) exposing a second length of adhesive tape on said roll of continuous tape; and
c) repeating steps a) and b) of claim 9 a plurality of times.

12. A method for cleaning a contact cleaning roller surface, comprising the steps of:
a) engaging a tape web with said contact cleaning roller surface;
b) passing a length of said tape web over said contact cleaning roller surface between a tape unwinder spindle and a tape winder spindle to clean said contact cleaning roller surface a first time; and
c) rewinding said length of said tape web over said contact cleaning roller surface toward said unwinder spindle to clean said contact cleaning roller surface a second time.
